(19) United States
(12) Patent Application Publication
(10) Pub. No.: US 2014/0334811 A1
(43) Pub. Date: Nov. 13, 2014

(54) Apparatus And Method For Conserving Power In A Passive Optical Network

(71) Applicant: Alcatel Lucent, Boulogne-Billancourt (FR)

(72) Inventors: Joseph L. Smith, Fuquay Varina, NC (US); Ronald Heron, Rigaud QUEBEC (CA); Edward E. Harstead, New York, NY (US); Peter J. Vetter, Summit, NJ (US)

(73) Assignee: Alcatel Lucent, Boulogne-Billancourt (FR)

(21) Appl. No.: 14/341,399

(22) Filed: Jul. 25, 2014

Related U.S. Application Data
(62) Division of application No. 13/293,369, filed on Nov. 10, 2011.

(51) Int. Cl. H04Q 11/00; H04B 10/032

(52) U.S. Cl. CPC H04Q 11/0067; H04B 10/032; H04Q 2011/0081
USPC 398/5

(57) ABSTRACT

An apparatus and method for cost-effectively conserving power in a PON. Protection ports, usually on a protection LT card, are configured to communicate with a selectable one of the downstream ODN splitter/combiners associated with the primary ports on the remaining LT cards of the OLT. Each protection port includes at least a splitter for distributing a transmitted signal from a light source to a plurality of switched protection fibers, and may have an optical amplifier to provide for lossless or low-loss distribution. Each port may also have a combiner for combining received signals from a plurality of switched protection fibers. Traffic flow through the OLT is monitored and when it is determined that traffic flow has reached a threshold level, traffic is routed via a protection port instead of a primary port. If the traffic rerouted to a protection card, then the method may further include powering down the primary LT card or placing it in a mode having reduced power consumption.

### CROSS-REFERENCE TO RELATED APPLICATIONS

The present disclosure is related to and claims priority from U.S. patent application Ser. No. 13/293,369, entitled Apparatus and Method for Providing Protection in a Passive Optical Network and filed on 10 Nov. 2011, the entire contents of which are incorporated by reference herein.

The present disclosure is related to U.S. patent application Ser. No. 13/033,379, entitled Low-Energy Optical Network Architecture and filed on 23 Feb. 2011, the entire contents of which are incorporated by reference herein.

### TECHNICAL FIELD

The present invention relates generally to the field of communications networks, and, more particularly, to apparatus and method for efficiently providing communication protection and energy conservation for a communications network such as a GPON.

### BACKGROUND

The following abbreviations are herewith defined, at least some of which are referred to within the following description of the state-of-the-art and the present invention.

APON ATM PON

ATM Asynchronous Transfer Mode

BER Bit Error Rate

BPON Broadband PON

CO Central Office

EPON Ethernet PON

GPON Gigabit PON

IEEE Institute of Electrical and Electronics Engineers

ITU International Telecommunication Union

ODN Optical Distribution Network

OLT Optical Line Terminal

ONT Optical Network Terminal

ONU Optical Network Unit

PIC Photonic Integrated Circuit

PON Passive Optical Network

SOA Semiconductor Optical Amplifier

SFP Small Form Factor Pluggable

VOA Variable Optical Attenuator

Note that the techniques or schemes described herein as existing or possible are presented as background for the present invention, but no admission is made thereby that these techniques and schemes were heretofore commercialized or known to others besides the inventors.

Operators of large communications networks, who are sometimes referred to as carriers or service providers, maintain widespread networks to handle many kinds of traffic, for example Internet access or television programming Telephone service may also be provided. These large networks may be conceptually divided into the core network and the access network or networks. The core networks carry large amounts of digitally-encoded information over high-capacity cables or other transmission media. Access networks are used by individual subscribers or other customers such as institutions or businesses to reach the core network.

A PON (passive optical network) is one type of access network. PONS use fiber optic cables to send light-energy signals carrying encoded information from the core network to the premises of a subscriber or group of subscribers, such as a home, apartment building or small business. The PON may in some cases reach only to a point accessible to the customer by other means such as a copper wire or wireless connection, although FTTH (fiber to the home) is becoming common. Wherever the demarcation point, however, the subscriber may connect a single device to the PON or, more commonly, have a network of their own that enables many devices to communicate with the network via the PON.

PONs use standard multiplexing schemes to permit communications to and from many different subscribers to be carried over one or a small number of cables, at least until the point where the communication channel must diverge to reach each individual subscriber premises. The transmission capacity of the PON is much lower than what is available in the core network, although it remains adequate to service a great number of subscribers.

PON standards have undergone a series of evolutions, for example APON, BPON, and EPON, GPON (gigabit PON), the latter two being currently in widespread use. Standards being developed include 10GEPON, xPON, and xGPON. Broadly speaking, the present invention is applicable and useful in all or most of the foreseeable evolutions of the basic PON concept.

A need exists to provide protection for the communications being handled by the PON. In the sense used here, “protection” refers to a practice of ensuring that an alternate communication path is available, where possible, in the event that a primary communication path is lost or degrades to an unacceptable level of quality. It is highly desirable, however, that this protection be provided as efficiently and cost-effectively as possible so that it may be practically and cost-effectively implemented, even in existing systems. These needs and other needs are addressed by the present invention.

### SUMMARY

In one aspect, the present invention is an OLT (optical line terminal) for a PON (passive optical network) including a plurality of primary ports, at least one protection port, where each protection port is configured to provide protection for a selected one of the primary ports, and a network controller configured for selecting protection of a primary port by the at least one protection port. The network controller resides, for example, on an NT (network termination) module, wherein the network controller is resident on the NT. In a preferred embodiment, OLT includes a plurality of LT (line termination) cards, and the primary ports are distributed across the plurality of LT cards. In this embodiment, at least one protection port is configured to protect a selected one of a sub-set of the plurality of primary ports, wherein the subset of primary ports is resident on the plurality of LT cards. Preferably, the subset of the plurality of primary ports includes a single port on each of the plurality of LT cards.

The OLT of the present invention may be further characterized by a protection port including an optical splitter for splitting a downstream signal for transmission on a plurality of optical cables, where each optical cable associated with the protection of a primary port. The OLT may also include an optical amplifier such as an SOA (semiconductor optical amplifier) to amplify the downstream signal, and in this way compensate partially or fully for the loss of splitting the downstream signal. The OLT may further include an optical selector for selecting which optical cables of the plurality of optical cables to disable. On the receive side, the OLT protection port may include an optical combiner for combining upstream transmissions received from a plurality of optical cables, where the optical cables are associated with the protection of a respective primary port. The optical combiner is preferably a mode coupling receiver. In an alternate embodiment an optical combiner and an optical amplifier to amplify the upstream signal may be present, The present invention may be further characterized by a network controller for selecting which optical cables of the plurality of optical cables to disable may be present, and the network controller for the transmit side and the receive side of one or more protection ports may be a single device. The network controller may, for example, reside on an NT card in the OLT.

In another aspect, the present invention is a method for the protection of primary ports of an OLT in a PON including detecting the failure of a communication channel having an ODN optical splitter between a primary port and one or more CPE (customer premises equipment) devices, disabling the primary port, switching the protection port to communicate with the one or more CPE devices via the optical splitter, and routing communications between the OLT and the one or more CPE devices through the protection port. The method may further include determining whether a protection port associated with the primary port is available prior to disabling the primary port, and disabling the primary port only if a protection port is available.

In yet another aspect, the present invention can also be used as a method of conserving power in an OLT including monitoring traffic flow through the OLT, determining when the traffic flow has reached a threshold level, and routing traffic via a protection port instead of a primary port. If the traffic from each of the ports on a primary LT card is rerouted to a protection card, then the method may further include powering down the primary LT card or placing it in a mode having reduced power consumption. The protection ports of the protection card may use time-division sharing or some other scheme to handle the traffic from a number of primary ports so that more than one primary LT card may be powered down or placed in a reduced-power state in this manner.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating a typical PON in which an embodiment of the present invention may be implemented;

FIG. 2 is a simplified schematic diagram illustrating a PON according to an embodiment of the present invention;

FIG. 3 is a simplified schematic diagram illustrating an optical module according to an embodiment of the present invention;

FIG. 4 is a flow diagram illustrating a method of providing PON protection according to an embodiment of the present invention; and

FIG. 5 is a flow diagram illustrating a method of power conservation using PON protection according to an embodiment of the present invention.

### DETAILED DESCRIPTION

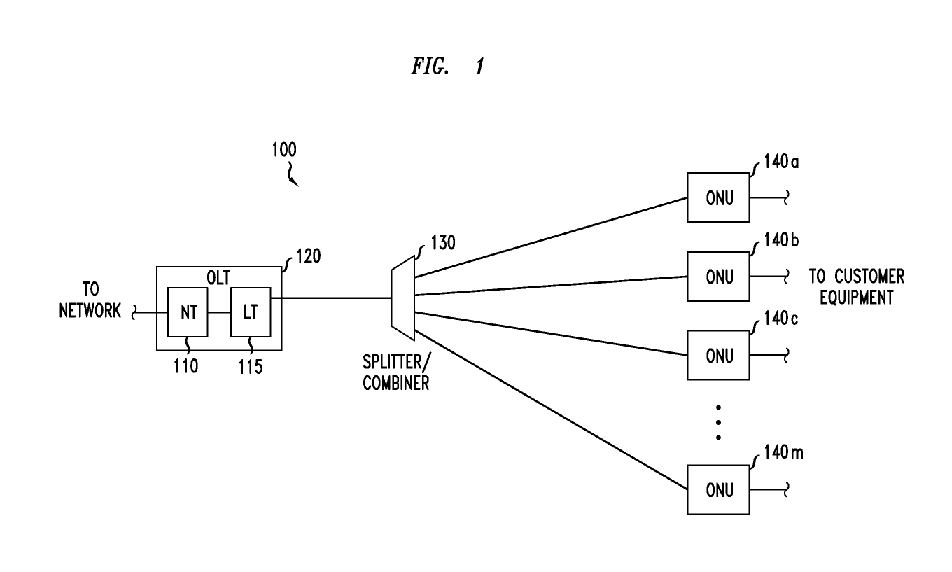

The present invention is directed at a manner of providing efficient communication protection for optical communications networks. As mentioned above, a PON typically provides a connection between a core network and individual subscribers. FIG. 1 is a simplified schematic diagram illustrating a typical PON 100 in which an embodiment of the present invention may be implemented. PON 100 extends from OLT 120 to the ONUs 140a through 140m. OLT 120 is typically located in the CO (central office) of a carrier or service provider and is connected to the main or core part of the carrier's network (not shown). Note that the PON 100 of FIG. 1 is simplified for convenience; in a typical implementation, there may be a large number of OLTs. Generally speaking, however, the layout depicted in FIG. 1 is representative across the network.

OLT 120, like each of the OLTs in a typical deployment, serves a number of ONUs, handling communication traffic both from the network in a downstream direction and from the individual ONUs in an upstream direction. Shown in FIG. 1 are ONUs 140a through 140m. In many cases the ONU is located at the subscriber's premises and is connected to a home gateway or router or similar equipment (not shown) owned or provided by the subscriber.

OLT 120 itself is also simplified for convenience. In FIG. 1 OLT 120 includes an LT (line terminal) module 115 and an NT (network terminal) module 110. Each of the modules may be implemented on a separate card or printed circuit board. The NT module 110 acts as an interface with the core network for upstream traffic and routes downstream traffic to the appropriate LT module or modules for transmission to subscribers. A single LT module 115 is depicted in FIG. 1. The LT module 115 interfaces with the subscriber lines. The communications between the NT module 110 and the LT module 115 are typically electronic signals, so the LT module 115 converts electrical signals to optical signals in the downstream direction and received optical signals into electrical signals in the upstream direction.

In the PON 100 of FIG. 1, a separate fiber optic cable is routed to each of the subscriber ONUs 140a through 140m. These separate fibers do not, however, extend all the way from the OLT 120. Instead the optical signals for ONUs 140a through 140m are transmitted to a power splitter/combiner 130. The splitter/combiner 130 divides the optical signal, which is then sent to each of the ONUs. Typically, only the content intended for the respective subscriber is passed along by the ONU. Communications from the ONUs are usually sent according to a schedule determined by the OLT 120, and to directed splitter/combiner 130 for upstream transmission to LT module 115.

As might be expected, it is advantageous to place the splitter/combiner 130 relatively closer to the subscribers than to the CO to minimize the amount of fiber that is needed for distribution to the end user. The splitter/combiner 130 may, for example, reside (along with a number of other such devices) in an “outside plant” such as street cabinet. It should be noted in this regard that the illustration of FIG. 1 is not to scale and the splitter/combiner 130 is shown as centrally located only for clarity.

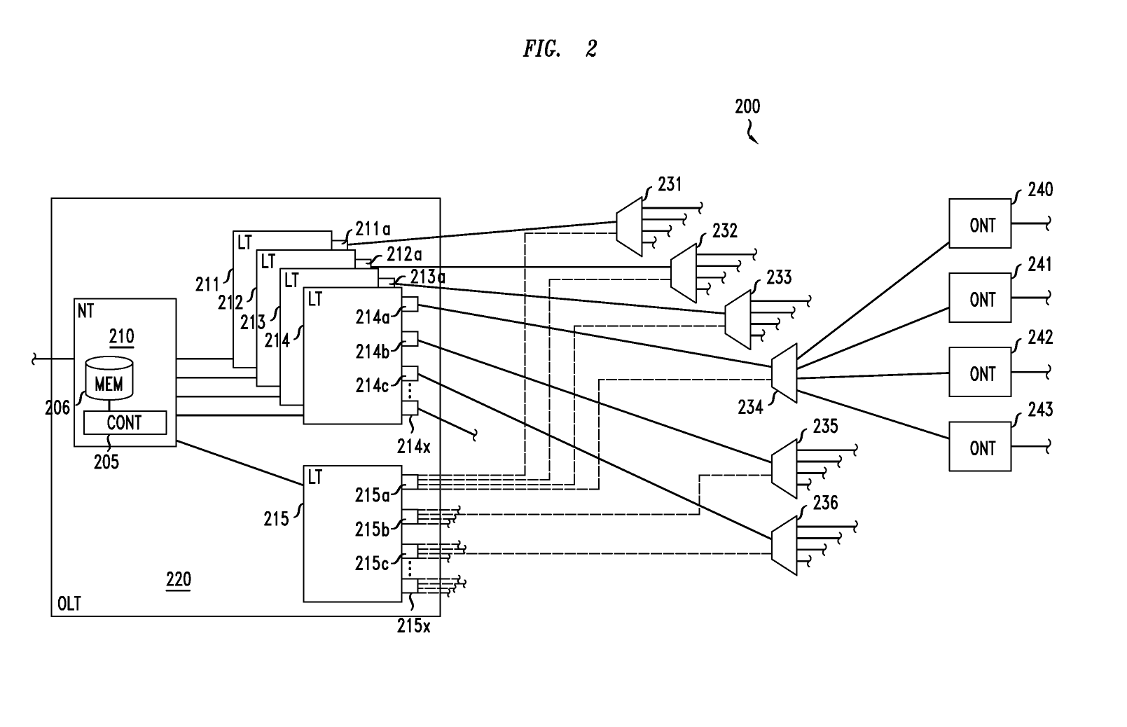

As mentioned above, there will typically be in the OLT a number of LT modules, and they will often reside each on their own respective card. Each card can therefore be removed and replaced separately, for example for maintenance or testing purposes. This is more clearly illustrated in FIG. 2. FIG. 2 is a simplified schematic diagram illustrating a PON 200 according to an embodiment of the present invention. Here, an OLT 220 is shown to have five LT cards 211 through 215, each in communication with NT card 210. In an actual implementation, of course, there could be more LT cards or fewer.

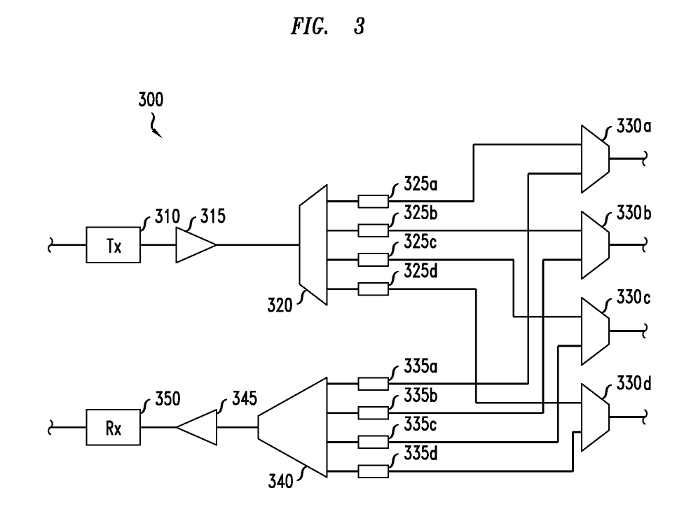

In the embodiment of FIG. 2, network controller 206 resides on NT card 210 and is in communication with physical memory device 206. Network controller 206 may be implemented in hardware or in the alternative in hardware executing software program instructions stored for example on memory device 206. Network controller 206 controls the function of various components of NT card, for example to effect the correct routing of data traffic to the LT cards 211 through 215. It may also control the operation of other components of OLT 220 including, for example, the optical switches illustrated in FIG. 3.

In the embodiment of FIG. 2, each of the LT cards has a number of downstream ports referred to as a through x in FIG. 2, although not all of the ports are shown. Each port is associated with an ODN splitter/combiner in a fashion similar to that illustrated in FIG. 1. For example, port 211a of LT card 211 is in communication with ODN splitter/combiner 231, port 212a of LT card 212 is in communication with ODN splitter/combiner 232, and port 213a of LT card 213 is in communication with ODN splitter/combiner 233, each by a respective fiber optic cable.

Also visible in FIG. 2 are ports 214a through 214x of LT card 214 and the connections of ports 214a through 214c to ODN splitter/combiners 234, 235, and 236, respectively. Port 214x (and any additional ports represented by ellipsis) are connected in similar fashion. The same is true for the remaining ports of LT cards, 211 through 213. In this context, it is noted that in implementation not all ports of each card are necessarily utilized, and there may be more or fewer cards present in a particular OLT.

In FIG. 2, exemplary ONUs 240 through 243 are also shown, and are served by ODN splitter/combiner 234. Note that although four ONUs are shown, there could be fewer in communication with splitter/combiner 234, though in most implementations there will be more. Although not shown in FIG. 2, the remaining splitter/combiners are similarly connected as is appropriate to the number of individual subscribers requiring service.

In accordance with the present invention, ODN splitter/combiners 231 through 236 are not 1:m but 2:m (or, in the illustrated embodiment, 2:4). That is, each of the illustrated ODN splitter/combiners has an additional fiber optic connection (shown as a broken line) to OLT 220. In this embodiment, LT card 215 has been configured as a protection card. For this reason, port 215a of LT card 215 has a fiber optic connection to ODN combiner/splitters 231 through 234. Also shown in FIG. 2 are the connections between port 215b and 215c to combiner/splitters 235 and 236, respectively. The remaining connections from the ports of LT card 215 are similarly made although omitted from FIG. 2 for clarity. Note that this arrangement is preferred, but other arrangements of connections between the protection and primary cards are also possible.

It is noted that in this embodiment, the port 215a of LT card 215 provides protection for primary ports 211a, 212a, 213a, and 214a. Similarly, protection port 215b provides protection for primary port 214b, and for the “b” ports (not shown) of LT cards 211 through 213. The connection between protection port 215b and splitter combiner 235, which is also in communication with primary port 214b, is illustrated in FIG. 2. Also illustrated is the connection between protection port 215c and ODN splitter/combiner 236, which is also in communication with primary port 214c.

In operation, when a failure or unacceptable degradation of quality is detected at a primary port, communications to and from the OLT 220 may be routed instead from the corresponding protection port until the failure has been remedied. For example, if a failure of communications between port 214a and splitter combiner 234 is detected, then communication between OLT 220 and splitter combiner is shifted to protection port 215a. This process will be described in more detail below.

The apparatus of the present invention may also be employed for conserving energy usage in the OLT even where an actual failure has not occurred. Note that herein the LT card used is the same or similar to the LT card used only for failure protection, and for convenience it will be referred to as a protection card regardless of its current function.

As should be apparent, the protection scheme of this embodiment involves using one (or in some cases more) of the LT cards as a protection card. As used herein, this means that at least one of the ports on the protection card is used to provide a communication path from the OLT to a plurality of splitters that are also connected to a primary port. In the preferred embodiment of FIG. 2, the protection card (LT card 215) employs all its available ports for this purpose. Each protection port may of course be used to protect any other primary port, but preferably each protection port protects primary ports that are not the same LT card. Of course, under this scheme if not all of the ports on the other LT cards are being utilized, some ports on the protection card may also go unused.

It should be noted that in this embodiment of the present invention, each protection port is configured to handle the communications associated with one primary port at a time. Protecting multiple ports residing on different LT cards helps to reduce the likelihood that protection for multiple ports will be required simultaneously. If a given LT card is being replaced, for example, a single protection card may be sufficient for protecting the communications the primary LT card's ports would normally handle. The protection scheme of the present invention is therefore efficient to deploy, and may often be implemented with only relatively-minor adjustments to existing equipment. Note, however, that in some embodiments a single protection port may be allocated to protection of a number of primary ports on a time-division or other basis.

In one embodiment, at least some of the protection fiber optic cables are routed diversely from the OLT to their respective ODN splitter/combiner so that a local event damaging one does not also damage the other.

In accordance with the present invention, the protection ports on the protection card or module are in communication with a plurality of downstream devices such as ODN splitter/combiners 231 through 236 shown in FIG. 2. In order to accomplish this, each protection port includes an optical module configured according to the present invention. FIG. 3 is a simplified schematic diagram illustrating an optical module 300 according to an embodiment of the present invention.

In this embodiment, optical module 300 includes a transmitter 310 for generating an optical signal and including a light source such as LED or laser. In many implementations, the transmitter 310 is similar or identical to the transmitters used in the primary ports. Downstream of the transmitter 310 is an optical amplifier 315 for amplifying the generated optical signal. This is to help ensure that signal from the protection port is at or near the energy level of the primary port signal that it is intended to replace, after having been split by splitter 320. This may not be required in all implementations but is strongly preferred.

In the embodiment of FIG. 3, downstream of optical amplifier 315 is an optical splitter 320 for distributing the signal among the separate protection fiber optic cables. Note that while four such fibers are shown in FIG. 3, there could be any number within the limitations of the splitter 320 (and combiner 340). In this embodiment, four pairs (that is, transmit and receive) of fibers are shown corresponding to the four LT cards being protected in FIG. 2. Each pair provides protection for a selected one (or in some cases more) out of a subset of the ports, for example the subset consisting of primary ports 211a, 212a, 213a, and 214a. Again, however, the number of LT cards may vary, as may the members of a subset protected by a given protection port.

In the embodiment of FIG. 3, it is not intended that the signal from transmitter 310 will be sent to more than one downstream splitter/combiner at a time, so a number of optical switches 325a through 325d are provided, one on each fiber extending downstream from splitter 320. The optical switches may, for example, may be implemented by VOAs (variable optical attenuators) or MEMS (micro-electro-mechanical systems). Note that in other embodiments (not shown), other schemes may be used, for example, using a wavelength-multiplex signal, for transmitting to more than one down stream fiber. In such an embodiment, optical switches 325a through 325d may still be present.

In the embodiment of FIG. 2, the optical switches 325a through 325d are controlled by a network controller (for example, network controller 205 of FIG. 2) such that the distributed optical signal is passed along only a selected one of the downstream fibers. The network controller may be located on the LT card, the NT card, or at some other location within the OLT. The network controller is implemented in hardware or software executing on a hardware device. A table in a physical memory device (for example memory 206 shown in FIG. 2) in communication with the network controller may be used to register the state of each optical switch.

In the embodiment of FIG. 3, downstream of the optical switches are WDM splitter/combiners respectively referred to as 330a through 330d. The purpose of the WDM splitter/combiners is to permit optical signals in both the upstream and downstream direction to be transmitted on a single fiber optic cable between the WDM splitter/combiner and the ODN splitter/combiner (not shown in FIG. 3) that will distribute the downstream signal to the ONUs (see FIGS. 1 and 2).

In this embodiment, in the upstream direction from WDM splitter/combiners 330a through 330d are optical switches 335a through 335d, which may be operated by a network controller (not shown in FIG. 3) to control which of the optical fibers collected at combiner 340 will be allowed to pass a signal. A table in a physical memory device (also not shown in FIG. 3) in communication with the network controller may be used to register the state of each optical switch. When the signal arrives at combiner 340 it is passed through optical amplifier 345 before reaching optical receiver 350. Here again, the optical amplifier is not required but may be used to compensate partially or fully for the loss due to the optical combiner. In another preferred embodiment, a receiver device such as a mode coupling receiver may be used instead of the optical combiner and amplifier arrangement of FIG. 3.

In a preferred embodiment, the optical module is implemented in a pluggable optic module (for example an SFP) that is attached to the LT card, although the optical selector may also be implemented in hardware on the LT card itself. Where a pluggable module is used, there is an advantage that existing ports may be converted into protection ports with relative ease.

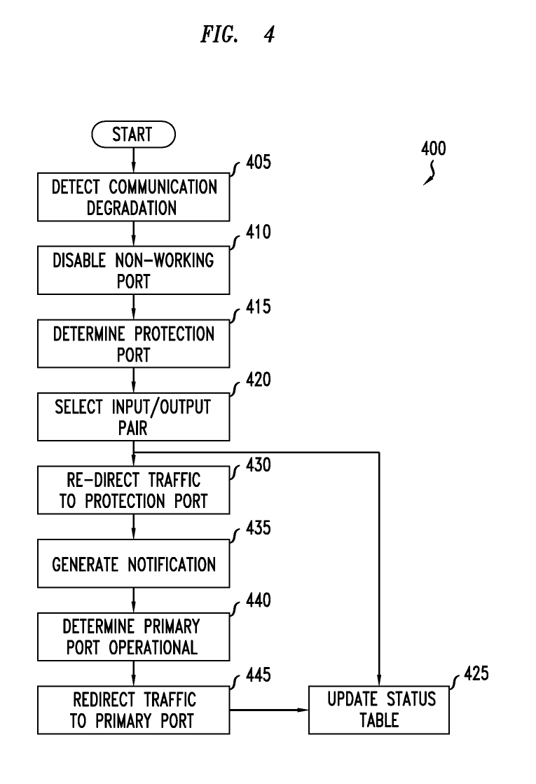

FIG. 4 is a flow diagram illustrating a method 400 of providing PON protection according to an embodiment of the present invention. At START it is presumed that the components configured to perform the method are present and operable according to the present invention. The process then begins when an OLT detects degradation (step 405) in the communications at a primary port. This degradation may be a complete failure or simply an attenuation of the communications below an acceptable quality (an excessive BER, for example). The detection may be performed by the OLT itself or received as a message from another network entity.

In this embodiment, the non-working port is then disabled (step 410) such that no further transmissions are sent from it. There may be signals received, but in most implementations they are simply ignored until the port is re-activated. The protection port corresponding to the disabled port is then determined (step 415). The optical selector then selects the appropriate input/output pair (step 420). Referring to FIG. 3, selecting the pair includes determining which fiber optic cables downstream of splitter 320 and combiner 340 should be used for the protection communications and setting the optical switches 325a through 325d and 335a through 335d, as appropriate. A status table in the OLT is updated (step 425) to indicate the status of each optical switch that has been set.

In the embodiment of FIG. 4, once the optical switches have been set appropriately, the NT card begins routing communication traffic (step 430) to the protection port determined to correspond to the disabled port. Naturally, communication received at the protection port will be handled as if they had been received at the primary port. In this embodiment, the OLT then generates (step 435) a notification message to alert the network operator. Traffic will continue to be routed through the protection port until it is determined that the primary port is operational (step 440), at which time traffic is directed to the primary port (step 445). Preferably, at this time the optical switches of the protection port are all disabled (not separately shown) and left in that condition until the protection port is needed. Naturally, of the protection port is being shared with another primary port, the optical switches will be or remain set accordingly. In either case, appropriate updates are made to the status table (step 425).

Note that method 400 is only one embodiment of the present invention and some variation is possible. Operations may be added, for example, or in some embodiments omitted. In addition, the operations of the method may be performed in any logically consistent order. For example, the primary port may be disabled only after the protection port has been determined and the appropriate downstream fibers selected.

In an alternate embodiment (not shown), a determination is also made that the appropriate protection port is available. Under some circumstances, it may already be in use. If it is not available, then a number of options are available. The process could simply be abandoned, of course, although preferably the availability of the protection port would be checked periodically. Alternately, the current settings could simply be over-ridden such that a given protection port is dedicated for the primary port that failed most recently. In another embodiment, a time division sharing arrangement may be possible, with the protection port handling the communications for respective primary ports at assigned times.

Here it is also noted that the protection port may be used for other reasons than an actual failure of the primary port. For example, the “failure” detection may be indicated by the network operator so that maintenance may be performed or simply to route traffic more efficiently. In one embodiment (not shown), in periods of light traffic the protection ports may be used on a time-division basis to handle traffic for a number of primary ports. In this embodiment the traffic may be monitored and traffic levels compared to a threshold, so that a determination may be made as to when the protection ports may advantageously be used in this manner. Once a determination is made, protection port optical fiber pairs are selected and traffic rerouted as described above.

Ports and cards may be powered-down or placed on standby or sleep mode as their traffic load is rerouted. This savings could be significant if the protection card is able to handle traffic that would otherwise be handled by several other LT cards. Naturally, when the protection ports and protection card are not in use, they may be powered-down as well.

In another alternate embodiment (not shown), when traffic is low (for example at night time or when only a relatively small number of ONUs are being served) all ODN are connected to the protection LT card , which then functions as the active card. The other LT cards are powered off or placed in a low-power stand-by state. When traffic increases above a certain threshold, one or more primary LT cards can be powered on. The switches in the protection SFP are now configured such that the traffic passing via the corresponding ODNs is terminated in the primary LT card.

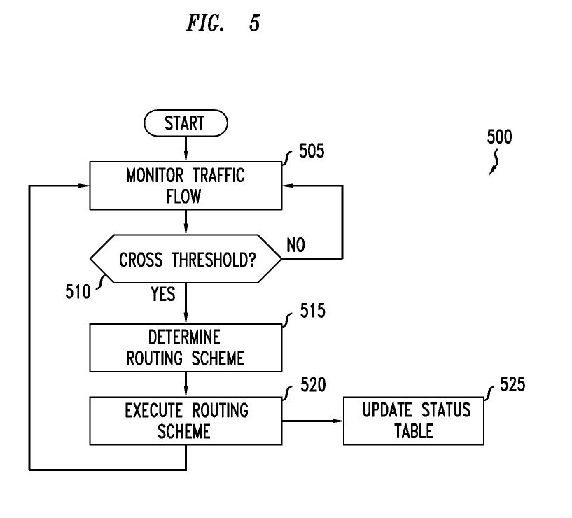

FIG. 5 is a flow diagram illustrating a method 500 of providing PON protection according to an embodiment of the present invention. At START it is presumed that the components configured to perform the method are present and operable according to the present invention (see, for example, FIG. 2). The process then begins with monitoring the traffic flow through an OLT (step 505). A determination is then made as to whether a traffic threshold has been reached (step 510). If not, the process simply returns to step 505 and monitoring continues. If it has been determined at step 510, however, that a threshold has been reached then a new routing scheme is formulated (step 515).

In an alternate embodiment (not shown), a routing override message may be received in the OLT. In other words, the formulation of a new routing scheme may be performed for reasons unconnected to traffic monitoring. This message may have originated at an operator-input device or may have come from a scheduler that enforces at certain times a mandatory re-formulation of the routing scheme. In this alternate embodiment, the override message may also include a mandatory routing scheme, in which case the outcome of step 515 is pre-determined.

Where no mandatory routing scheme is being enforced, the network controller (see, for example, FIG. 2), determines the current state of each of the LT cards, including the protection card. The traffic flow though each LT card may also be considered. If the traffic flow is at a high level then in most implementations the primary LT cards (for example LT cards 211 through 214 shown in FIG. 2) will remain active and the protection LT card (for example LT card 215 shown in FIG. 2) will be powered down or placed in a low-power standby state unless it is already being used (for example, if one or more primary ports have failed). If the traffic flow is at a low level, on the other hand, a routing scheme may be formulated such that all of the OLT traffic is handled by the protection LT. In this case, the primary LT cards may be placed in a reduced-power state (either powered down or placed on standby) but are available for protection in case one or more the primary ports fail. For an intermediate traffic flow, the reformulation of step 515 may include having the protection LT handle traffic from one or more but not all of the primary LT cards. In this case, if a failure is experienced in one of the active primary LT cards, the inactive LT cards may have to be returned to full power so that they can handle their own traffic and the protection LT card is able to provide protection for the failed port.

In the embodiment of FIG. 3, the network controller then executes the new routing scheme (step 520). As with failure protection, this includes ensuring that traffic is routed to the proper primary or protection port. Where a protection port is changing function, optical switches in the protection port optical modules (see, for example, FIG. 3) may be used to enable or disable downstream fibers appropriately. The execution of step 520 also includes adjusting the power state of affected LT cards. A schedule may also have to be established for handling traffic from more than one primary port at a protection port. A status table is updated (step 525) to reflect the new routing scheme an the status of the protection port optical switches. The process then returns to step 505 and the traffic flow is monitored for further changes.

If the apparatus of the present invention is used for power saving, the number N of primary LT cards may advantageously be dimensioned for the ratio of low traffic to peak traffic (for example, if night time traffic is 25% of the peak traffic, N may be chosen as 4). The scheme offers the same protection during low traffic hours as during peak traffic hours, but the roles are reversed; the protection LT card is active and primary cards 1 to N are in a low power stand-by state. Switch-over from the protection LT card to the primary LT cards can be controlled by monitoring the traffic flow until it reaches a threshold, or switch-over can be scheduled during the day based on an average evolution of the traffic (for example, using a day—night cycle).

It is also noted that re-ranging may have to occur whenever traffic is re-routed to or from a protection port, especially if the protection fiber is routed differently than the primary one.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of conserving power in a PON OLT comprising a plurality of LT cards, the method comprising:
configuring at least one of the LT cards as a protection LT card, wherein at least one of the ports of the protection LT card is in communication with a plurality of ODN splitter combiners over a plurality of optical fibers;
monitoring the flow of traffic through the OLT;
determining whether the traffic flow has fallen below a traffic threshold level;
formulating, if it is determined that the traffic flow has fallen below the traffic threshold level, a routing scheme routing at least some of the OLT traffic through the protection LT card; and
executing the routing scheme.

2. The method of claim 1, further comprising placing at least one non-protection LT card in a reduced power state.

3. The method of claim 2, further comprising placing a plurality of non-protection LT cards in a reduced power state.

4. The method of claim 1, further comprising determining that the traffic flow has risen above the threshold level and formulating a routing scheme routing the OLT traffic through the non-protection LT cards.

5. The method of claim 4, further comprising placing the LT protection card in a reduced power state.

6. The method of claim 1, further comprising:
determining whether the traffic flow has fallen below an intermediate traffic threshold level; and
formulating, if it is determined that the traffic flow has fallen below the intermediate traffic threshold level, a routing scheme routing at least some of the OLT traffic through the protection LT card.
